(19) United States
(12) Patent Application Publication
(10) Pub. No.: US 2017/0207905 A1
(43) Pub. Date: Jul. 20, 2017

(54) FLY FEEDBACK

(71) Applicant: QUALCOMM Incorporated, San Diego, CA (US)

(72) Inventors: Alecsander Eitan, Haifa (IL); Ran Hay, Rosh Haaein (IL); Javier Frydman, Tel-Mond (IL); Gal Basson, Haifa (IL); Amichai Sanderovich, Atlit (IL)

(21) Appl. No.: 15/403,782

(22) Filed: Jan. 11, 2017

Related U.S. Application Data
(60) Provisional application No. 62/278,895, filed on Jan. 14, 2016.

(51) Int. Cl. H04L 7/027; H04L 12/26; H04L 29/06; H04L 25/02; H04L 5/00

(52) U.S. Cl. CPC H04L 7/0276; H04L 25/0202; H04L 5/0055; H04L 69/22; H04L 43/16; H04L 5/0048

(57) ABSTRACT

In certain aspects of the present disclosure an apparatus for wireless communication comprises a processing system and an interface. The processing system is configured to generate a preamble and a first data portion of a frame, wherein the preamble includes information for receiving the frame at a device, receive a message from the device, wherein the message provides feedback of reception of the first data portion by the device, and generate a second data portion of the frame. The interface is configure to output the preamble and the first data portion of the frame for transmission to the device, and output the second data portion of the frame for transmission to the device, wherein transmission of the first and second data portions of the frame are separated in time by a gap, and the message is received within the gap.

### RELATED APPLICATION

This application claims priority under 35 U.S.C. §119(e) to U.S. Provisional Application No. 62/278,895 filed on Jan. 14, 2016, the entire specification of which is incorporated herein by reference.

### FIELD

Certain aspects of the present disclosure generally relate to wireless communications and, more particularly, to providing feedback in a wireless communications system.

### BACKGROUND

In order to address the issue of increasing bandwidth requirements demanded for wireless communications systems, different schemes are being developed. In some schemes, data is wirelessly transmitted at high data rates over one or more channels in the 60 GHz range.

### SUMMARY

One aspect relates to an apparatus for wireless communication. The apparatus comprises a processing system configured to generate a preamble and a first data portion of a frame, wherein the preamble includes information for receiving the frame at a device, receive a message from the device, wherein the message provides feedback of reception of the first data portion by the device, and generate a second data portion of the frame. The apparatus also comprises an interface configured to output the preamble and the first data portion of the frame for transmission to the device, and output the second data portion of the frame for transmission to the device, wherein transmission of the first and second data portions of the frame are separated in time by a gap, and the message is received within the gap.

A second aspect relates to a method for wireless communication. The method comprises generating a preamble and a first data portion of a frame, wherein the preamble includes information for receiving the frame at a device, outputting the preamble and the first data portion of the frame for transmission to the device, and receiving a message from the device, wherein the message provides feedback of reception of the first data portion by the device. The method also comprises generating a second data portion of the frame, and outputting the second data portion of the frame for transmission to the device, wherein transmission of the first and second data portions of the frame are separated in time by a gap, and the message is received within the gap.

A third aspect relates to an apparatus for wireless communication. The apparatus comprises means for generating a preamble and a first data portion of a frame, wherein the preamble includes information for receiving the frame at a device, means for outputting the preamble and the first data portion of the frame for transmission to the device, and means for receiving a message from the device, wherein the message provides feedback of reception of the first data portion by the device. The apparatus also comprises means for generating a second data portion of the frame, and means for outputting the second data portion of the frame for transmission to the device, wherein transmission of the first and second data portions of the frame are separated in time by a gap, and the message is received within the gap.

A fourth aspect relates to a computer readable medium. The computer readable medium comprises instructions executable for generating a preamble and a first data portion of a frame, wherein the preamble includes information for receiving the frame at a device, outputting the preamble and the first data portion of the frame for transmission to the device, and receiving a message from the device, wherein the message provides feedback of reception of the first data portion by the device. The computer readable medium also comprises instructions executable for generating a second data portion of the frame, and outputting the second data portion of the frame for transmission to the device, wherein transmission of the first and second data portions of the frame are separated in time by a gap, and the message is received within the gap.

A fifth aspect relates to a wireless node. The wireless node comprises a processing system configured to generate a preamble and a first data portion of a frame, wherein the preamble includes information for receiving the frame at a device, receive a message from the device, wherein the message provides feedback of reception of the first data portion by the device, and generate a second data portion of the frame. The wireless node also comprises a transmitter configured to transmit the preamble and the first data portion of the frame to the device, and transmit the second data portion of the frame to the device, wherein transmission of the first and second data portions of the frame are separated in time by a gap, and the message is received within the gap.

A sixth aspect relates to an apparatus for wireless communications. The apparatus comprises a processing system configured to receive, from a device, a preamble of a frame, receive a first data portion of the frame using the preamble, wherein the first data portion of the frame includes a plurality of data blocks, and determine one or more of the plurality of data blocks received in error by the apparatus. The processing system is also configured to generate a message, wherein the message indicates the one or more of the plurality of data blocks, and receive a second portion of the frame using the preamble. The apparatus also comprises an interface configured to output the message for transmission to the device between reception of the first and second data portions of the frame.

A seventh aspect relates to a method for wireless communication. The method comprises receiving, from a device, a preamble of a frame, receiving a first data portion of the frame using the preamble, wherein the first data portion of the frame includes a plurality of data blocks, and determining one or more of the plurality of data blocks received in error. The method also comprises generating a message, wherein the message indicates the one or more of the plurality of data blocks, outputting the message for transmission to the device, and receiving a second portion of the frame using the preamble, wherein the message is output for transmission between reception of the first and second data portions of the frame.

An eighth aspect relates to an apparatus for wireless communications. The apparatus comprises means for receiving, from a device, a preamble of a frame, means for receiving a first data portion of the frame using the preamble, wherein the first data portion of the frame includes a plurality of data blocks, and means for determining one or more of the plurality of data blocks received in error. The apparatus also comprises means for generating a message, wherein the message indicates the one or more of the plurality of data blocks, means for outputting the message for transmission to the device, and means for receiving a second portion of the frame using the preamble, wherein the message is output for transmission between reception of the first and second data portions of the frame.

A ninth aspect relates to a computer readable medium. The computer readable medium comprises instructions executable for receiving, from a device, a preamble of a frame, receiving a first data portion of the frame using the preamble, wherein the first data portion of the frame includes a plurality of data blocks, and determining one or more of the plurality of data blocks received in error. The computer readable medium also comprises instructions executable for generating a message, wherein the message indicates the one or more of the plurality of data blocks, outputting the message for transmission to the device, and receiving a second portion of the frame using the preamble, wherein the message is output for transmission between reception of the first and second data portions of the frame.

A tenth aspect relates to an apparatus for wireless communications. The apparatus comprises a processing system configured to receive, from a device, a preamble of a frame, receive a first data portion of the frame using the preamble, wherein the first data portion of the frame includes a plurality of data blocks, and determine one or more of the plurality of data blocks received in error by the apparatus. The processing system is also configured to generate a message, wherein the message indicates the one or more of the plurality of data blocks, and receive a second portion of the frame using the preamble. The apparatus also comprises a transmitter configured to transmit the message to the device between reception of the first and second data portions of the frame.

### BRIEF DESCRIPTION OF THE DRAWINGS

FIG. 1 illustrates an exemplary wireless communication system in accordance with certain aspects of the present disclosure.

FIG. 2 is a block diagram of an exemplary access point and access terminal in accordance with certain aspects of the present disclosure.

FIG. 3 illustrates an example of a large data transmission according to an existing feedback scheme.

FIG. 4 illustrates an example of a large data transmission according to certain aspects of the present disclosure.

FIG. 5 illustrates a feedback message according to certain aspects of the present disclosure.

FIG. 6 illustrates feedback data in the feedback message according to certain aspects of the present disclosure.

FIG. 7 is a flowchart of a method for wireless communication in accordance with certain aspects of the present disclosure.

FIG. 8 is a flowchart of a method for wireless communication in accordance with certain aspects of the present disclosure.

FIG. 9 illustrates an exemplary device in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple access terminals. A TDMA system may allow multiple access terminals to share the same frequency channel by dividing the transmission signal into different time slots, each time slot being assigned to different access terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

With reference to the following description, it shall be understood that not only communications between access points and user devices are allowed, but also direct (e.g., peer-to-peer) communications between respective user devices are allowed. It shall also be understood that communications between access points are also allowed, for example, to form a wireless backhaul link between the access points. In this example, a first one of the access points may be coupled to a network via a wired link (e.g., optical fiber) and a second one of the access points may communicate with one or more user devices. The wireless backhaul link provides the second access point with a backhaul link to the network, for example, in cases where a wired link (e.g., optical fiber) to the network is not available at the second access point. Furthermore, a device (e.g., an access point or user device) may change its behavior between a user device and an access point according to various conditions. Also, one physical device may play multiple roles: user device and access point, multiple user devices, multiple access points, for example, on different channels, different time slots, or both.

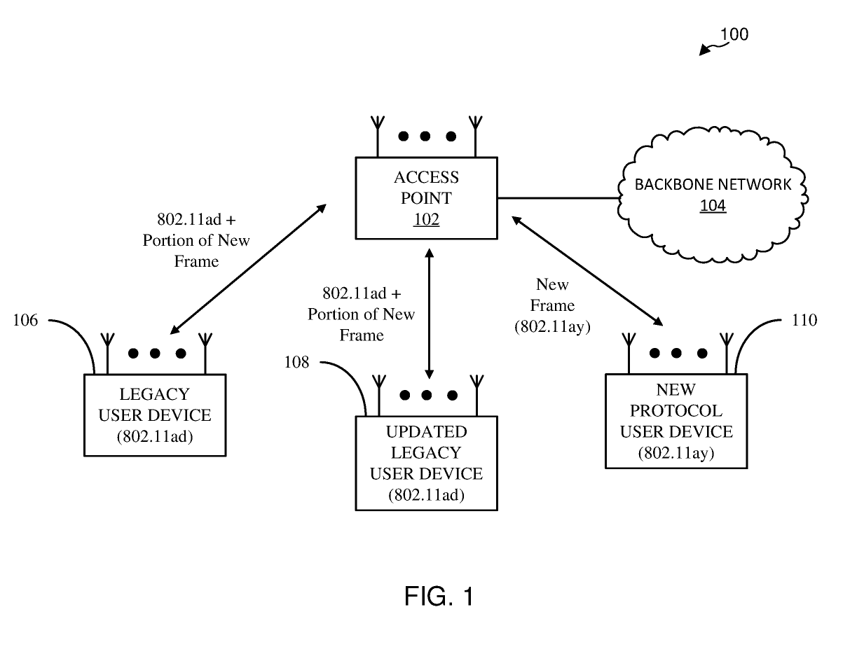

FIG. 1 is a diagram of an exemplary wireless communications network 100 in accordance with certain aspects of the present disclosure. The communication network 100 comprises an access point 102, a backbone network 104, a legacy user device 106, an updated legacy user device 108, and a new protocol user device 110.

The access point 102, which may be configured for a wireless local area network (LAN) application, may facilitate data communications between the user devices 106, 108, and 110. The access point 102 may further facilitate data communications between devices coupled to the backbone network 104 and any one or more of the user devices 106, 108, and 110.

In this example, the access point 102 and the legacy user device 106 data communicate between each other using a legacy protocol. One example of a legacy protocol includes IEEE 802.11ad. According to this protocol, data communications between the access point 102 and the legacy user device 106 are effectuated via transmission of data frames that comply with the 802.11ad protocol. As discussed further herein, an 802.11ad data frame includes a preamble consisting of a legacy short training field (L-STF) and a legacy channel estimation field (L-CEF), a legacy header (L-Header), a data payload, and an optional beamforming training field.

The L-STF sequence includes a plurality of Golay sequences (Ga₁₂) and a negative Golay sequence (−Ga₁₂) to signify the end of the L-STF sequence. The L-STF sequence may assist a receiver in setting up its automatic gain control (AGC), timing, and frequency setup for accurately receiving the rest of the frame and subsequent frames. In the case of a single carrier (SC) transmission mode, the L-CEF sequence includes a Gu₅₁₂ sequence consisting of the following concatenated Golay sequences (−Gb₁₂₈, −Ga₁₂₈, Gb₁₂₈, −Ga₁₂₈) followed by a Gv₅₁₂ sequence (consisting of the following concatenated Golay sequences (−Gb₁₂₈, Ga₁₂₈, −Gb₁₂₈, −Ga₁₂₈), and ending with a Gv₁₂₈ (same as −Gb₁₂₈) sequence. In the case of an orthogonal frequency division multiplexing (OFDM) transmission mode, the L-CEF sequence includes a Gv₅₁₂ sequence followed by a Gu₅₁₂ sequence, and ending with a Gv₁₂₈ sequence. The L-CEF sequence assists the receiver in estimating the channel over which the frame is sent.

The L-Header includes various information about the frame. Such information includes a scrambler initiation field, which specifies a seed for the scrambling applied to the remainder of the L-Header and the data payload for data whitening purposes. The L-Header also includes the modulation and coding scheme (MCS) field to indicate one out of 12 defined MCS used for transmitting the data payload of the frame. The L-Header includes a length field to indicate the length of the data payload in octets. The L-Header further includes a training length field to indicate a length of the optional beam forming training sequence at the end of the frame. Additionally, the L-Header includes a packet type field to indicate whether the optional beam forming field pertains to transmission or reception. Further, the L-Header includes an HCS field to indicate a CRC-32 checksum over the header bits.

Referring again to FIG. 1, the legacy user device 106 is capable of decoding the entire 802.11ad data frame. The new frame disclosed herein, which may be subsequently adopted for the new standard or protocol 802.11ay, provides some backward compatibility features. As discussed in more detail herein, the new frame includes the preamble (L-STF and L-CEF) and the L-Header of the 802.11ad, and one or more additional portions pertaining to the new protocol. Accordingly, the legacy user device 106 is configured to decode the 802.11ad preamble (L-STF and L-CEF) and L-Header portion of the new frame, but is not configured to decode the remaining portion of the new frame. The legacy user device 106 may decode the 802.1 lad preamble and header portion of the new frame in order to calculate a network allocation vector (NAV) to determine the length of the new frame for transmission collision avoidance purposes.

The updated legacy user device 108 also operates under the legacy 802.11ad protocol, and is able to communicate with the access point 102 using 802.11ad data frames. However, the frame processing capability of the updated legacy user device 108 has been updated to interpret certain bits in the L-Header of the new frame that indicate an attribute of the new frame, as discussed further herein. In accordance with the legacy 802.11ad protocol, these bits are allocated to least significant bits (LSB) of the data length in the L-Header. But, in accordance with the new frame, the otherwise allocated bits of the L-Header are used to indicate a transmission power difference between a first portion of the new frame and a second portion of the new frame in accordance with a certain transmission mode associated with the new frame. These bits allow the updated legacy user device to anticipate the power difference (an increase) for signal interference management purposes. Although, in this example, the allocation of the LSB length bits signify the aforementioned power difference, it shall be understood that these bits may be allocated for other purposes.

The new protocol user device 110 is capable of communicating with the access point 102 using the new data frame, which some or all features of the new frame may be adopted for the 802.11ay protocol. As discussed further herein, the new data frame includes the legacy 802.11ad preamble (L-STF and L-CEF) and L-Header, with the L-Header slightly modified to indicate the transmission mode associated with the new frame and, as previously discussed, a transmission power difference between a first portion of the new frame and a second portion of the new frame. The slight modification to the L-Header of the new frame does not impact the decoding of the L-Header by the legacy user device 106 and the updated legacy user device 108. The bits in the L-Header of the new frame that indicate the transmission mode are reserved bits in the standard 802.11ad legacy header.

In addition to the legacy preamble (L-STF and L-CEF) and L-Header, the new frame further comprises an Extended Directional Multigigabit (EDMG) Header. As discussed in more detail herein, the EDMG Header comprises a plurality of fields for indicating various attributes of the new frame. Such attributes includes payload data length, number of low density parity check (LDPC) data blocks in the EDMG Header, the number of spatial streams supported, the number of bonded channels, the leftmost (lowest frequency) channel of the bonded channels, the MCS used for the data payload of the new frame, the transmit power difference between different portions of the frame, and other information. The EDMG Header may further be appended with payload data that is not in the data payload portion of the new frame. For short messages, all of the payload data may appended to the EDMG Header, thereby avoiding the need for transmitting the “separate” data payload portion of the new frame, which adds significant overhead to the frame.

The new data frame is configured to provide additional features to improve data throughput by employing higher data modulation schemes, channel bonding, channel aggregation, and improved spatial transmission via multiple input multiple output (MIMO) antenna configurations. For instance, the legacy 802.11ad protocol includes BPSK, QPSK, and 16QAM available modulation schemes. According to the new protocol, higher modulation schemes, such as 64QAM, 64APSK, 128APSK, 256QAM, and 256APSK are available. Additionally, a plurality of channels may be bonded or aggregated to increase data throughput. Further, such bonded or aggregated channels may be transmitted by way of a plurality of spatial transmissions using a MIMO antenna configuration.

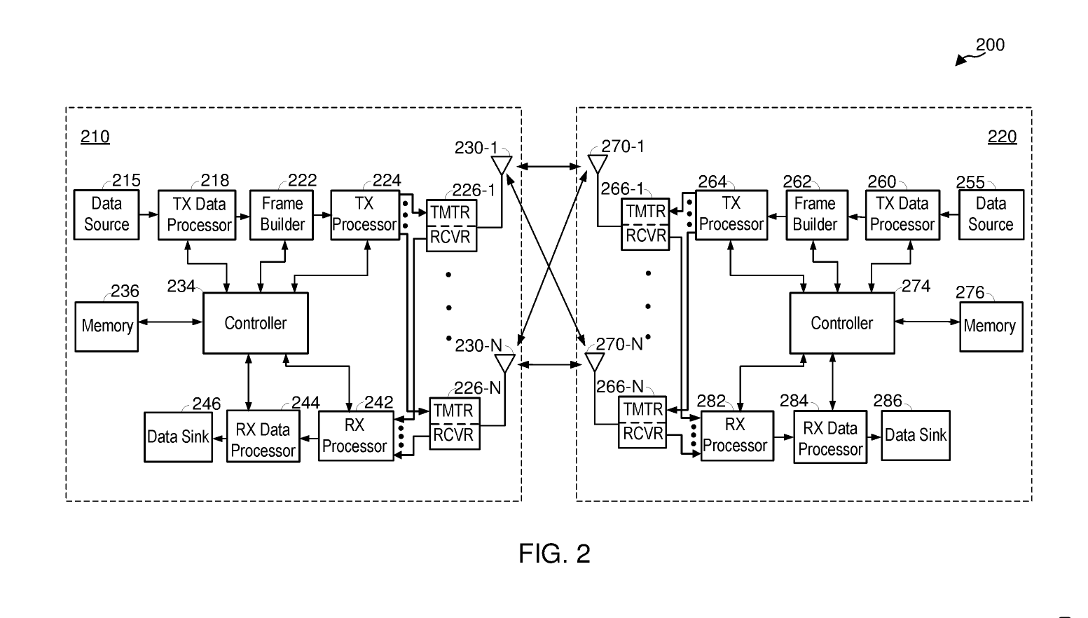

FIG. 2 illustrates a block diagram of an access point 210 (generally, a first wireless node) and an access terminal 220 (generally, a second wireless node) of the wireless communication system 200. The access point 210 is a transmitting entity for the downlink and a receiving entity for the uplink. The access terminal 220 is a transmitting entity for the uplink and a receiving entity for the downlink. As used herein, a “transmitting entity” is an independently operated apparatus or wireless node capable of transmitting data via a wireless channel, and a “receiving entity” is an independently operated apparatus or wireless node capable of receiving data via a wireless channel.

Although, in this example, wireless node 210 is an access point and wireless node 220 is an access terminal, it shall be understood that the wireless node 210 may alternatively be an access terminal, and wireless node 220 may alternatively be an access point. The wireless node 210 may be used to implement the access point 102 in FIG. 1, and the wireless node 220 may be used to implement any one of the user devices 106, 108 and 110 in FIG. 1. In another example, the wireless nodes 210 and 220 may both be access terminals with direct (e.g., peer-to-peer) communications between the access terminals. In still another example, the wireless nodes 210 and 220 may both be access points with a wireless backhaul link between the access points.

For transmitting data, the access point 210 comprises a transmit data processor 218, a frame builder 222, a transmit processor 224, a plurality of transceivers 226-1 to 226-N, and a plurality of antennas 230-1 to 230-N. The access point 210 also comprises a controller 234 configured to control operations of the access point 210, as discussed further below.

In operation, the transmit data processor 218 receives data (e.g., data bits) from a data source 215, and processes the data for transmission. For example, the transmit data processor 218 may encode the data (e.g., data bits) into encoded data, and modulate the encoded data into data symbols. The transmit data processor 218 may support different modulation and coding schemes (MCSs). For example, the transmit data processor 218 may encode the data (e.g., using low-density parity check (LDPC) encoding) at any one of a plurality of different coding rates. Also, the transmit data processor 218 may modulate the encoded data using any one of a plurality of different modulation schemes, including, but not limited to, BPSK, QPSK, 16QAM, 64QAM, 64APSK, 128APSK, 256QAM, and 256APSK.

In certain aspects, the controller 234 may send a command to the transmit data processor 218 specifying which modulation and coding scheme (MCS) to use (e.g., based on channel conditions of the downlink), and the transmit data processor 218 may encode and modulate data from the data source 215 according to the specified MCS. It is to be appreciated that the transmit data processor 218 may perform additional processing on the data such as data scrambling, and/or other processing. The transmit data processor 218 outputs the data symbols to the frame builder 222.

The frame builder 222 constructs a frame (also referred to as a packet), and inserts the data symbols into a data payload of the frame. Exemplary frame structures or formats are discussed further below. The frame builder 222 outputs the frame to the transmit processor 224. The transmit processor 224 processes the frame for transmission on the downlink. For example, the transmit processor 224 may support different transmission modes such as an orthogonal frequency-division multiplexing (OFDM) transmission mode and a single-carrier (SC) transmission mode. In this example, the controller 234 may send a command to the transmit processor 224 specifying which transmission mode to use, and the transmit processor 224 may process the frame for transmission according to the specified transmission mode.

In certain aspects, the transmit processor 224 may support multiple-output-multiple-input (MIMO) transmission. In these aspects, the access point 210 includes multiple antennas 230-1 to 230-N and multiple transceivers 226-1 to 226-N (e.g., one for each antenna). The transmit processor 224 may perform spatial processing on the incoming frames and provide a plurality of transmit frame streams for the plurality of antennas. The transceivers 226-1 to 226-N receive and process (e.g., convert to analog, amplify, filter, and frequency upconvert) the respective transmit frame streams to generate transmit signals for transmission via the antennas 230-1 to 230-N.

For transmitting data, the access terminal 220 comprises a transmit data processor 260, a frame builder 262, a transmit processor 264, a plurality of transceivers 266-1 to 266-N, and a plurality of antennas 270-1 to 270-N. The access terminal 220 may transmit data to the access point 210 on the uplink, and/or transmit data to another access terminal (e.g., for peer-to-peer communication). The access terminal 220 also comprises a controller 274 configured to control operations of the access terminal 220, as discussed further below.

In operation, the transmit data processor 260 receives data (e.g., data bits) from a data source 255, and processes (e.g., encodes and modulates) the data for transmission. The transmit data processor 260 may support different MCSs. For example, the transmit data processor 260 may encode the data (e.g., using LDPC encoding) at any one of a plurality of different coding rates, and modulate the encoded data using any one of a plurality of different modulation schemes, including, but not limited to, BPSK, QPSK, 16QAM, 64QAM, 64APSK, 128APSK, 256QAM, and 256APSK. In certain aspects, the controller 274 may send a command to the transmit data processor 260 specifying which MCS to use (e.g., based on channel conditions of the uplink), and the transmit data processor 260 may encode and modulate data from the data source 255 according to the specified MCS. It is to be appreciated that the transmit data processor 260 may perform additional processing on the data. The transmit data processor 260 outputs the data symbols to the frame builder 262.

The frame builder 262 constructs a frame, and inserts the received data symbols into a data payload of the frame. Exemplary frame structures or formats are discussed further below. The frame builder 262 outputs the frame to the transmit processor 264. The transmit processor 264 processes the frame for transmission. For example, the transmit processor 264 may support different transmission modes such as an OFDM transmission mode and an SC transmission mode. In this example, the controller 274 may send a command to the transmit processor 264 specifying which transmission mode to use, and the transmit processor 264 may process the frame for transmission according to the specified transmission mode.

In certain aspects, the transmit processor 264 may support multiple-output-multiple-input (MIMO) transmission. In these aspects, the access terminal 220 includes multiple antennas 270-1 to 270-N and multiple transceivers 266-1 to 266-N (e.g., one for each antenna). The transmit processor 264 may perform spatial processing on the incoming frame and provide a plurality of transmit frame streams for the plurality of antennas. The transceivers 266-1 to 266-N receive and process (e.g., convert to analog, amplify, filter, and frequency upconvert) the respective transmit frame streams to generate transmit signals for transmission via the antennas 270-1 to 270-N.

For receiving data, the access point 210 comprises a receive processor 242, and a receive data processor 244. In operation, the transceivers 226-1 to 226-N receive signals (e.g., from the access terminal 220) via the antennas 230-1 to 230-N, and process (e.g., frequency downconvert, amplify, filter and convert to digital) the received signals.

The receive processor 242 receives the outputs of the transceivers 226-1 to 226-N, and processes the outputs to recover data symbols. For example, the access point 210 may receive data (e.g., from the access terminal 220) in a frame. In this example, the receive processor 242 may detect the start of the frame using the STF sequence in the preamble of the frame. The receive processor 242 may also use the STF for automatic gain control (AGC) adjustment. The receive processor 242 may also perform channel estimation (e.g., using the CE sequence in the preamble of the frame) and perform channel equalization on the received signal based on the channel estimation.

The receive processor 242 may also recover information (e.g., MCS scheme) from the header of the frame, and send the information to the controller 234. After performing channel equalization, the receive processor 242 may recover data symbols from the frame, and output the recovered data symbols to the receive data processor 244 for further processing. It is to be appreciated that the receive processor 242 may perform other processing.

The receive data processor 244 receives the data symbols from the receive processor 242 and an indication of the corresponding MSC scheme from the controller 234. The receive data processor 244 demodulates and decodes the data symbols to recover the data according to the indicated MSC scheme, and outputs the recovered data (e.g., data bits) to a data sink 246 for storage and/or further processing.

As discussed above, the access terminal 220 may transmit data using an OFDM transmission mode or a SC transmission mode. In this case, the receive processor 242 may process the receive signal according to the selected transmission mode. Also, as discussed above, the transmit processor 264 may support multiple-output-multiple-input (MIMO) transmission. In this case, the access point 210 includes multiple antennas 230-1 to 230-N and multiple transceivers 226-1 to 226-N (e.g., one for each antenna). Each transceiver receives and processes (e.g., frequency downconverts, amplifies, filters and converts to digital) the signal from the respective antenna. The receive processor 242 may perform spatial processing on the outputs of the transceivers 226-1 to 226-N to recover the data symbols.

For receiving data, the access terminal 220 comprises a receive processor 282, and a receive data processor 284. In operation, the transceivers 266-1 to 266-N receive signals (e.g., from the access point 210 or another access terminal) via the antennas 270-1 to 270-N, and process (e.g., frequency downconvert, amplify, filter and convert to digital) the received signals.

The receive processor 282 receives the outputs of the transceivers 266-1 to 266-N, and processes the outputs to recover data symbols. For example, the access terminal 220 may receive data (e.g., from the access point 210 or another access terminal) in a frame, as discussed above. In this example, the receive processor 282 may detect the start of the frame using the STF sequence in the preamble of the frame. The receive processor 282 may also perform channel estimation (e.g., using the CE sequence in the preamble of the frame) and perform channel equalization on the received signal based on the channel estimation.

The receive processor 282 may also recover information (e.g., MCS scheme) from the header of the frame, and send the information to the controller 274. After performing channel equalization, the receive processor 282 may recover data symbols from the frame, and output the recovered data symbols to the receive data processor 284 for further processing. It is to be appreciated that the receive processor 282 may perform other processing.

The receive data processor 284 receives the data symbols from the receive processor 282 and an indication of the corresponding MSC scheme from the controller 274. The receiver data processor 284 demodulates and decodes the data symbols to recover the data according to the indicated MSC scheme, and outputs the recovered data (e.g., data bits) to a data sink 286 for storage and/or further processing.

As discussed above, the access point 210 or another access terminal may transmit data using an OFDM transmission mode or a SC transmission mode. In this case, the receive processor 282 may process the receive signal according to the selected transmission mode. Also, as discussed above, the transmit processor 224 may support multiple-output-multiple-input (MIMO) transmission. In this case, the access terminal 220 includes multiple antennas 270-1 to 270-N and multiple transceivers 266-1 to 266-N (e.g., one for each antenna). Each transceiver receives and processes (e.g., frequency downconverts, amplifies, filters and converts to digital) the signal from the respective antenna. The receive processor 282 may perform spatial processing on the outputs of the transceivers to recover the data symbols.

As shown in FIG. 2, the access point 210 also comprises a memory 236 coupled to the controller 234. The memory 236 may store instructions that, when executed by the controller 234, cause the controller 234 to perform one or more of the operations described herein. Similarly, the access terminal 220 also comprises a memory 276 coupled to the controller 274. The memory 276 may store instructions that, when executed by the controller 274, cause the controller 274 to perform the one or more of the operations described herein.

### On the Fly Feedback

The IEEE 802.11ay standard is being developed to extend the throughput of the existing IEEE 802.11ad standard. The physical layer (PHY) throughput of IEEE 802.11ay will reach up to 100 Gbps per user or aggregated users.

Such a high PHY throughput causes severe efficiency degradation if the existing feedback (BACK) scheme according to the IEEE 802.11ad standard is used. This issue may be addressed by adding very large buffers to the MAC layer, increasing the solution cost. In addition, medium use efficiency is also affected by TCP ACK messages in the reverse direction of large traffic data.

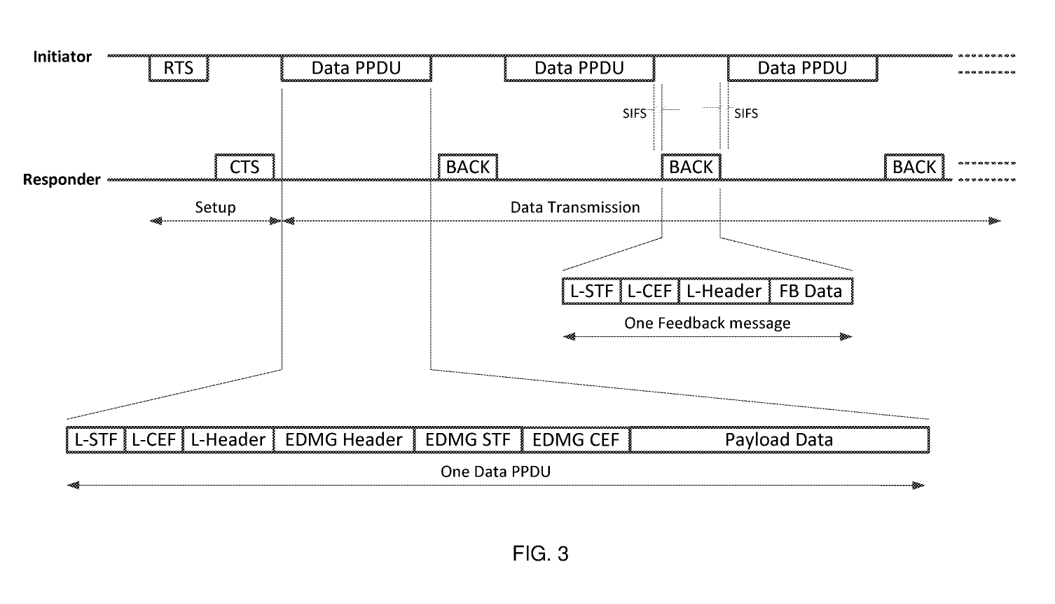

The efficiency loss caused by the BACK and TCP ACK is caused by the fact that after some amount of data has been sent using the high rate PHY, a small packet needs to be sent in the reverse direction to provide feedback. This can be explained with reference to FIG. 3, which shows an example of transmission using the existing method.

In the example in FIG. 3, an initiator transmits a large amount of data to a responder. The initiator may be an AP (e.g., AP 210) or an AT (e.g., 220), and the responder may be AP (e.g., AP 210) or an AT (e.g., 220). During transmission setup, the initiator sends a request to send (RTS) message to the responder indicating that the initiator has data to transmit, and the responder sends a clear to send (CTS) message in response to the RTS message indicating that the responder is ready to receive the data. The RTS and CTS messages may each include a duration value signaling to other wireless devices that can hear the RTS and CTS messages to avoid using the medium for the duration of the data transmission for collision avoidance.

The initiator then transmits the data using a plurality of PLCP protocol data units (PPDUs). Each PPDU includes a preamble and a payload. In this example, the preamble includes L-STF, L-CEF, L-Header, EDMG Header, EDMG STF and EDMG CEF, which are discussed above. The EDMG Header may be a type “A” EDMG Header referred to as EDMG Header-A. The payload includes a portion of the data being transmitted, and may be divided into a plurality of data blocks.

After receiving a PPDU, the responder transmits a feedback (BACK) message to the initiator providing feedback of reception of the data in the PPDU by the responder. In this example, the feedback (BACK) message includes L-STF, L-CEF, L-Header and Feedback (FB) data. The Feedback (FB) data may include a block acknowledgement (BA) indicating which data blocks in the PPDU, if any, were received in error by the responder.

After receiving the feedback message, the initiator transmits the next PPDU to the responder. The next PPDU includes a preamble (L-STF, L-CEF, L-Header, EDMG Header, EDMG STF and EDMG CEF) and payload. The payload may include new data blocks. If one or more data blocks in the previous PPDU were received in error by the responder (as indicated in the feedback message), the payload also includes the one or more data blocks for retransmission to the responder.

In this example, the overhead of sending one feedback message includes the following:
Inter-message space: SIFS (3 usec)
The feedback message: L-STF (1.23 usec), L-CEF (0.65 usec), L-Header (0.58), One Data block (0.29 usec)
Inter-message space: SIFS (3 usec)
Restart next large packet: L-STF (1.23 usec), L-CEF (0.65 usec), L-Header (0.58 usec), and EDMG-Header (0.58 usec) (Note that additional fields will be needed for high data rates)
   In this example, a total of 11.8 usec are used for sending a very small amount of feedback data. At high PHY rates this time will reduce the medium utilization down to 35% using exiting BACK window of 64 blocks.

Embodiments of the present disclosure provide “On the Fly Feedback” that significantly reduces the overhead of sending feedback messages during large data transfers, by fast switching (much less than SIFS), smaller overhead (reduce/replace L-STF, L-CEF and L-Header) in the feedback message, and/or removing overhead in the next payload data.

“On the Fly Feedback” significantly improves the medium efficiency at high PHY rates and/or can be used to significantly reduce the memory requirements for the payload (driven by the BACK Window size). “On the Fly Feedback” according to certain aspects is used in cases where Link budget has high signal-to-noise ratio (SNR) (required for the high PHY data rate). In addition, “On the Fly Feedback” according to certain aspects improves (reduces) latency by faster data upload to receiver host and by faster TCP transmission.

In certain aspects, a high throughput transmission consists of a single (or aggregated) PPDU that will have a preamble (L-STF, L-CEF, L-Header, EDMG-Header, EDMG STF and EDMG CEF) only at the beginning. From time to time, the transmission will be interrupted by a small gap for the reverse link feedback and then proceed without a preamble.

In certain aspects, the Feedback (FB) transmission uses a new PHY mode, with a much smaller preamble than standard PHY frames, and is designed to carry a limited amount of payload bits. The FB transmission may also lack designated MAC overhead.

In certain aspects, the interval between forward and reverse transmission as well as the interval between reverse and forward transmission is much smaller, denoted as FBIFS (FeedBack InterFrame Space).

In certain aspects, the initiator signals the use of “On the Fly Feedback” in the Header (e.g. EDMG Header) as well as the periodicity of the feedback (e.g. in units of PHY Payload Symbols).

“On the Fly Feedback” according to certain aspects can be used when both stations support it and can be used in addition to the existing BACK scheme and half-duplex transmissions.

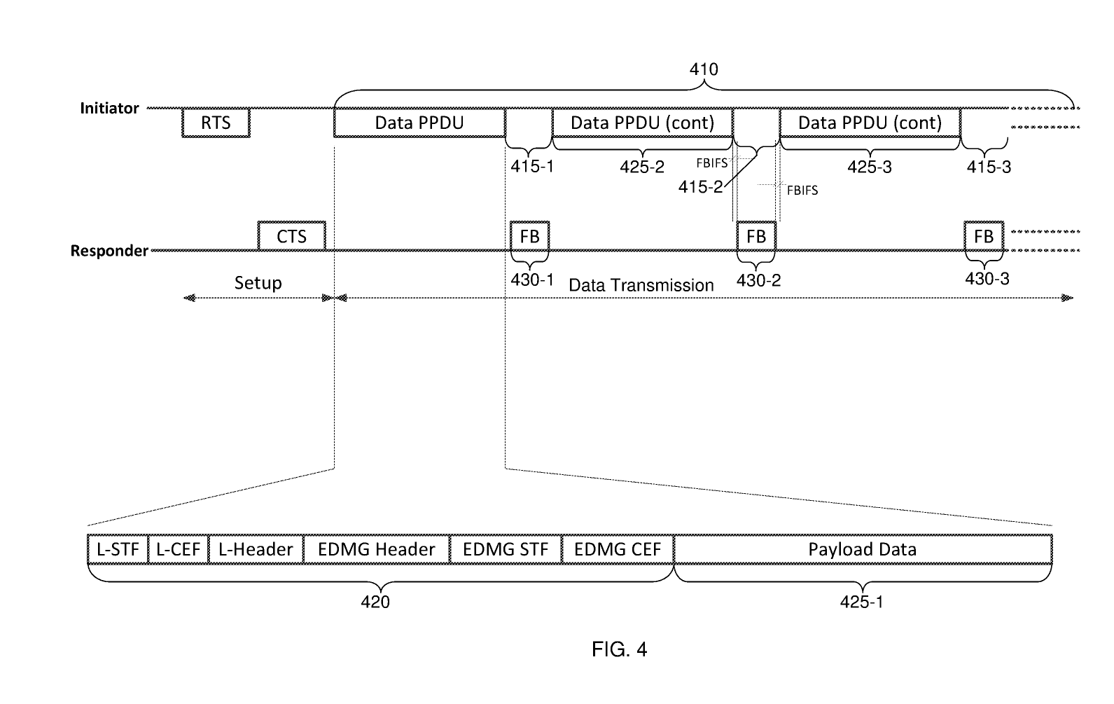

FIG. 4 shows an example of a large data transmission according to certain aspects of the present disclosure. In this example, the initiator transmits a long PPDU or frame 410 with small gaps 415-1 to 415-3 in the transmission for receiving feedback from the responder. The gaps 415-1 to 415-3 may be generated by the PHY layer without any impact on the MAC processing. In certain aspects, each gap may be 2 usec or less.

The frame 410 includes a preamble 420 at the beginning. The preamble 420 may include information (e.g., sequences and header) to assist the responder in receiving the frame 410. For example, the preamble 420 may include an STF (L-STF, EDMG STF, etc.) for allowing the responder to detect the frame 410 and perform timing and/or frequency synchronization. The responder may use timing synchronization to track the symbol timing of the frame 410 in order to properly decode the data in the frame. In another example, the preamble 420 may include a CEF (L-CEF, EDMG CEF, etc.) for allowing the responder to estimate the channel over which the frame is sent. The responder may then perform channel equalization using the estimated channel to correct the received frame for channel distortion. In the example in FIG. 4, the preamble 420 includes L-STF, L-CEF, L-Header, EDMG Header, EDMG STF and EDMG CEF. The EDMG Header may be a type “A” EDMG Header referred to as EDMG Header-A.

The frame 410 also includes a plurality of data portions 425-1 to 425-3 for transmitting the data. Each data portion includes a portion of the data payload of the frame 410. In certain aspects, data in the data portion may be transmitted at a high rate (e.g., 20 Gbps to 100 Gbps) using any one of a number of modulation schemes including, for example, 16QAM, 64QAM, 64APSK, 128APSK, 256QAM, and 256APSK.

The data portions 425-1 to 425-3 are separated by the small gaps 415-1 to 415-3. Within each gap 415-1 to 415-3, the initiator may receive a Feedback (FB) message 430-1 to 430-3 from the responder providing the initiator with feedback of data reception by the responder. In certain aspects, each FB message 430-1 to 430-3 has smaller overhead than the feedback (BACK) message in the existing BACK scheme. This may be achieved by reducing/replacing the L-STF, L-CEF and L-Header in the feedback message in FIG. 3, as discussed further below. The FB messages 430-1 to 430-3 may be transmitted at a lower rate (e.g., 4 Gbps) and/or lower modulation scheme (e.g., QPSK) than the data transmissions in the data portions.

In certain aspects, the spacing between a data portion and a FB message, denoted by FBIFS, may be much smaller than the inter-message spacing SIFS in FIG. 3. For example, FBIFS may be in the order of 0.1 usec.

In certain aspects, the preamble 420 is only transmitted at the beginning of the frame 410. The data portions of the frame do not include the preamble. Thus, when the data transmission is interrupted by a small gap 415-1 to 415-3 to receive feedback, the data transmission resumes (proceeds) after the gap without transmitting the preamble again. In contrast, each time a feedback (BACK) message is sent in FIG. 3, the next PPDU includes the preamble (L-STF, L-CEF, L-Header, EDMG Header, EDMG STF and EDMG CEF) at the beginning of the next PPDU. By not transmitting the preamble after each feedback message, aspects of the present disclosure significantly reduce the amount of overhead for sending each feedback message.

In certain aspects, each data portion 425-1 to 425-3 includes a plurality of data blocks. Each data block may include a portion of data in the respective data portion 425-1 to 425-3, and a check sequence (e.g., cyclic redundancy check (CRC)) for allowing the responder to perform error detection on the block to determine whether the block is received in error. In these aspects, when the responder receives a data portion 425-1 to 425-3, the responder determines whether one or more of the data blocks in the data portion 425-1 to 425-3 are received in error using the check sequences. If one or more of the data blocks are received in error, the responder may include a block acknowledgement (BA) in the corresponding FB message indicating the one or more data blocks received in error. For example, the BA may include a bitmap, in which each bit in the bitmap corresponds to one of the blocks in the data portion, and the value of each bit indicates whether the respective block was received in error. In this example, when the initiator receives the FB message, the initiator retransmits the one or more data blocks received in error (as indicated by the BA) in the next data portion. The next data portion may include the one or more data blocks as well as new data blocks.

In certain aspects, the initiator follows BACK rules regarding a BACK window. In this example, the initiator may clear data blocks from its transmitter buffers when the data blocks have been acknowledged by the responder, making room in the buffers for the next data blocks to be transmitted in the responder. When the initiator receives a FB message from the responder (e.g., with a BA bitmap), the initiator updates the BACK vector accordingly and allows the next blocks to be transmitted as allowed by the BACK window.

In certain aspects, the initiator may include an indicator in the preamble 420 (e.g., in the EDMG Header) indicating that “On the Fly Feedback” is in use. In these aspects, the responder decodes the indicator and determines that “On the Fly Feedback” according to aspects of the present disclosure is in use from the indicator. In this case, the responder generates FB messages according to aspects of the present disclosure, in which the FB messages have less overhead than the existing feedback (BACK) messages in FIG. 3.

The initiator may also include an indicator in the preamble 420 (e.g., in the EDMG Header) indicating the timing of the gaps 415-1 to 415-3 (e.g., start times of the gaps). For example, if the gaps 415-1 to 415-3 are periodic, the initiator may indicate the periodicity of the gaps (e.g., in units of PHY Payload Symbols). In these aspects, the responder transmits the FB messages within the gaps according to the indicated timing of the gaps (e.g., transmits a FB message after a FBIFS from an indicated start time of a gap).

In certain aspects, some time (implementation dependent-order of few usec) before a gap start, the responder may collect the available BACK information and build the corresponding FB message for reverse link transmission. At the gap, the responder transmits the FB message to the initiator.

In certain aspects, the responder constantly clears its receiver buffers by uploading blocks in the buffers to the receiver host to make room for the upcoming blocks. The responder has a BACK window room in the reconstruction buffer for incoming blocks (existing BACK mechanism). Hence, the initiator does not send more blocks than the responder can hold.

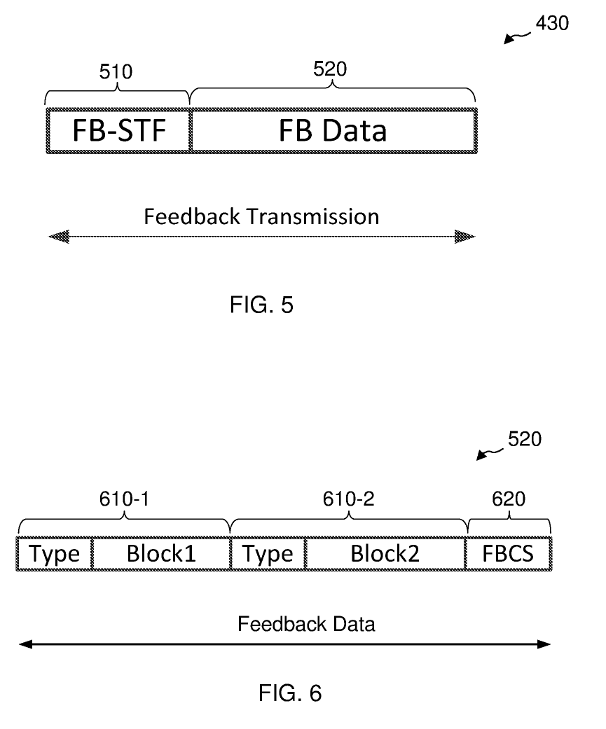

FIG. 5 shows an example of one of the Feedback (FB) messages 430 according to certain aspects. In the example in FIG. 5, the FB message 430 includes a FB-STF preamble 510 and a FB data portion 520. In this example, the L-CEF and L-Header in the existing feedback (BACK) message may be removed or reduced to reduce overhead.

The initiator uses the FB-STF 510 to detect the FB message 430. The initiator may use the FB-STF 510 to perform timing synchronization to track the symbol timing of the FB message to decode the FB data. The initiator may also use the FB-STF 510 to perform frequency synchronization (e.g., to track the frequency offset between the initiator and responder and correct for the frequency offset).

The initiator may also use the FB-STF 510 to perform channel estimation and perform channel equalization on the received FB data using the estimated channel. Thus, in this example, the initiator uses the FB-STF 510 for channel estimation instead of using a separate CEF to reduce overhead. This is possible because the FB-STF comprises a known sequence. Since the FB-STF 510 is known by the initiator, the initiator can use the received FB-STF 510 to deduce distortion caused by the channel, and therefore use the FB-STF 510 to estimate the channel. The FB-STF 510 may not provide as accurate a channel estimation as a CEF. To address this, the feedback FB message 430 may be sent when channel conditions are good, as discussed further below. This relaxes the requirements for the channel estimation. Further, the FB data 520 may be transmitted at a much lower rate than the data portions 425-1 to 425-3 (e.g., five to 25 times lower) and/or lower modulation scheme compared with the data portions, which may also relax the requirements for channel estimation. This allows the initiator to get by with using the FB-STF for channel estimation even though it may be less accurate.

FIG. 6 shows an example of the FB data 520 according to certain aspects. In this example, the FB data 520 includes one or more pairs 610-1 and 610-2 of a Type word followed by a respective data block (e.g., Block 1 and Block 2 in FIG. 6). Each Type word includes information about the type of the following block (including data block length) and a bit to signal if more pairs follow. For example, the Type word may indicate the type of feedback data in the block. The FB data 520 may also include a FBCS (Feedback Check Sequence) used to validate the correctness of the FB data. The initiator may use the FBCS to perform error detection on the FB data to determine whether the FB data is received in error. If the FB data is received in error, the initiator may request that the responder retransmit the FB data, as discussed further below.

Examples of data blocks in the FB data 520 will now be discussed according to certain aspects. In one example, the data blocks may include information similar to the “BA Control” and “BA information” in the IEEE 802.11ad standard. The information may be compressed, and may be modified by 802.11ay (e.g., larger supported BACK Window size). For instance, a data block may include a bitmap comprising a plurality of bits, where each bit corresponds to one of the data blocks in a data portion 425-1 to 425-3 transmitted by the responder, and the value of each bit indicates whether the respective data block was received in error.

In another example, a data block may include a MAC Frame—a block of data as received from the MAC. The MAC frame can be in a compressed format (e.g., only selected fields). For practical use-case, the MAC frame may be limited to a max length (e.g. 512 bit). Typically such MAC Frames can be TCP ACK.

In still another example, the responder may include a request in a data block to use a different format for a next FB message. In response to the request, the initiator may include an acknowledgement of the request in a next data portion. In response to the acknowledgement, the responder may transmit the next message using the different format.

As discussed above, the initiator may determine whether FB data in a FB message is received in error using the respective FBCS. In this example, the initiator may include a message in the data portion following the FB message indicating whether the FB data was successfully received by the initiator. If the message indicates that the FB data was successfully received (initiator acknowledges the FB data), the responder may send the FB data for the current data portion in the next FB message. In this case, the initiator may transmit new blocks in the current data portion as well as retransmit blocks from the previous data portion that were received in error by the responder (as indicated in the FB message).

If the message, on the other hand, indicates that the FB data was not successfully received, the initiator may transmit new data blocks in the current data portion (assuming the transmitter buffers and/or receiver buffers can hold data for two or more data portions). In this case, the responder may retransmit the FB data for the previous data portion in the next FB message. This FB message may also include the FB data for the current data portion. Thus, in this case, the size of the BA information may be increased since feedback is being provided for two data portions. For example, the size of the BA bitmap may be doubled, in which each bit in the bitmap corresponds to one of the data blocks in the previous data portion or current data portion, and the value of each bit indicates whether the respective block was received in error by the responder. After receiving the next FB message, the initiator may determine which blocks in the previous data portion and/or current data portion were received in error, and retransmit the blocks received in error in the data portion following the next FB message. In this example, when the BA information is increased, the corresponding Type in the FB data may indicate the size of the BA information. This allows the initiator to recognize that the BA information is for two data portions and process the BA information accordingly.

In certain aspects, the FBIFS corresponding to a switch from forward to reverse transmission (switch from data portion to FB message) may differ from the FBIFS corresponding to a switch from reverse to forward transmission (switch from FB message to data portion). This is because the transmitter to receiver switching time for the initiator may differ from the receiver to transmitter switching time for the initiator and/or the transmitter to receiver switching time for the responder may differ from the receiver to transmitter switching time for the responder. In other words, a first time duration between transmission of a data portion and reception of an FB message (e.g., FBIFS between the data portion and the FB message) may be different from a second time duration between reception of the FB message and transmission of the next data portion (e.g., FBIFS between the FB message and the next data portion).

In certain aspects, the responder may scramble the FB data 520 with a code (e.g., PN code) assigned to the responder before transmitting the FB data. In these aspects, the initiator may unscramble the received FB data 520 using the code to recover the FB data 520. This allows the initiator to recognize that the corresponding FB message is from the correct responder and that the FB data 520 is intended for the initiator. This is because, if the initiator is able to successfully unscramble the received FB data using the code assigned to the responder, then the initiator may determine that the FB message is from the correct responder (i.e., not from another responder sent in response to data transmission from another initiator). This assumes that FB data from another responder is scrambled with a different code. In this example, the scrambled FB data may appear as noise to other wireless devices. Thus, the initiator may determine that the source of the FB message is the responder and the destination of the FB message is the initiator by successfully unscrambling the FB data. Because the source and destination of the FB message are known from successfully unscrambling the FB data, the FB message does not need separate fields specifying the source and destination of the message, reducing overhead. For example, the source and destination fields in a MAC Frame (e.g., TCP ACK) in the FB message can be removed to reduce overhead since the source and destination are already known. In this case, the source and destination can be communicated to the MAC layer.

In certain aspects, the initiator and responder may support both “On the Fly Feedback” according to aspects of the present disclosure and the existing feedback (BACK) scheme. For example, the initiator may determine whether to use “On the Fly Feedback” or the existing feedback (BACK) scheme depending on the channel condition between the initiator and responder. In this example, the channel condition may be determined based on a signal-to-noise ratio (SNR) measurement at the initiator and/or responder, or other type of measurement (e.g., RSSI, SINR, etc.). In one example, the initiator may compare the determined channel condition with a threshold. If the determined channel condition is equal to or above the threshold indicating good channel condition, the initiator may select “On the Fly Feedback.” In this case, the initiator may indicate that “On the Fly Feedback” is in use in the preamble 420 to inform the responder that “On the Fly Feedback” is in use. In response, the responder generates and transmits FB messages 430-1 to 430-3 according to aspects of the present disclosure within the gaps 415-1 to 425-3.

If the determined channel condition is below threshold, the initiator may select the existing feedback (BACK) scheme. In this case, the initiator may transmit the data using multiple PPDUs, in which the preamble is transmitted in each PPDU (e.g., as shown in FIG. 3). In this case, the initiator may also indicate that the existing feedback (BACK) scheme is in use in the preamble 420 to inform the responder that the feedback (BACK) scheme is in use. In response, the responder provides feedback (BACK) messages according to the existing feedback (BACK) scheme between PPDUs (e.g., according to the IEEE 802.11 ad standard).

As discussed above, the responder may use a channel estimation field (CEF) in the preamble 420 of the frame 410 to estimate the channel over which the frame is transmitted. In this example, the responder may assume that the channel does not change much for the duration of the frame 410 (i.e., the estimated channel remains valid for the duration of the frame). For instance, at high data rates (e.g., 20 Gbps to 100 Gbps), a large amount of data may be transmitted in a short enough period for this assumption to hold. In this example, the responder may use the estimated channel determined from the CEF to perform channel equalization for each data portion 425-1 to 425-3 of the frame. Thus, the CEF does not need to be retransmitted after each FB message.

As discussed above, the responder may use a short training field (STF) in the preamble 420 to perform timing synchronization. In this example, the responder may use the STF to synchronize the timing of the receiver (e.g., receive processor 242 or 282) of the responder with the timing of the frame (e.g., symbol timing of the frame) to decode the data in the data portions. In certain aspects, the data portions 425-1 to 425-3 may include pilots distributed in the data portions to assist in maintaining time synchronization.

For example, each data portion may include a plurality of pilots, where each pilot may be located in a guard interval between adjacent data blocks in the data portion. In this example, the responder may track the timing of the frame using a timing tracking loop. The timing tracking loop may be initialized using the STF to synchronize the timing of the receiver with the timing of the frame at the beginning of the frame. The pilots may then be used to maintain the time tracking loop. At each pilot, the time tracking loop may estimate the timing of the frame (e.g., symbol timing of the frame) using the pilot, determine a difference between the estimated timing of the frame and the timing of the receiver, and adjust the timing of the receiver to reduce the difference to keep the timing of the receiver approximately synchronized with the timing of the frame (e.g., symbol timing of the frame). In the example, the gaps 415-1 to 415-3 between the data portions are small enough (e.g., two microseconds or less) that the time tracking loop is not broken by the gaps. In other words, the difference between the timing of the receiver and the timing of the frame stays small enough during the gap to maintain the time tracking. Thus, the STF does not need to be retransmitted after each FB message.

In certain aspects, when a number of data blocks are to be transmitted to the responder, the length of the frame 410 may be made longer than needed to transmit the number of blocks in order to accommodate retransmission of one or more of the blocks. In this regard, a first portion of the length is allocated for transmission of the data blocks, and a second portion of the length is allocated for retransmission of one or more of the data blocks. If the entire second portion of the length is not needed (e.g., all of the blocks are acknowledged by the responder), the initiator may end the frame 410 early (earlier than the designated length). In this case, the initiator may transmit a message indicating the end of the frame. This message may also be broadcasted to other devices (e.g., to inform the other devices that the medium is free). Thus, in this example, the length of the frame indicated in the preamble may be long enough to accommodate retransmission of one or more of the blocks.

In certain aspects, the responder and initiator may support different formats for the Feedback (FB) message. In these aspects, the responder may change the format by including a request in a FB message to use a different format for a next FB message. In response, the initiator may include an acknowledgement of the request in the following data portion. Upon receiving the acknowledgement, the responder may start using the new format.

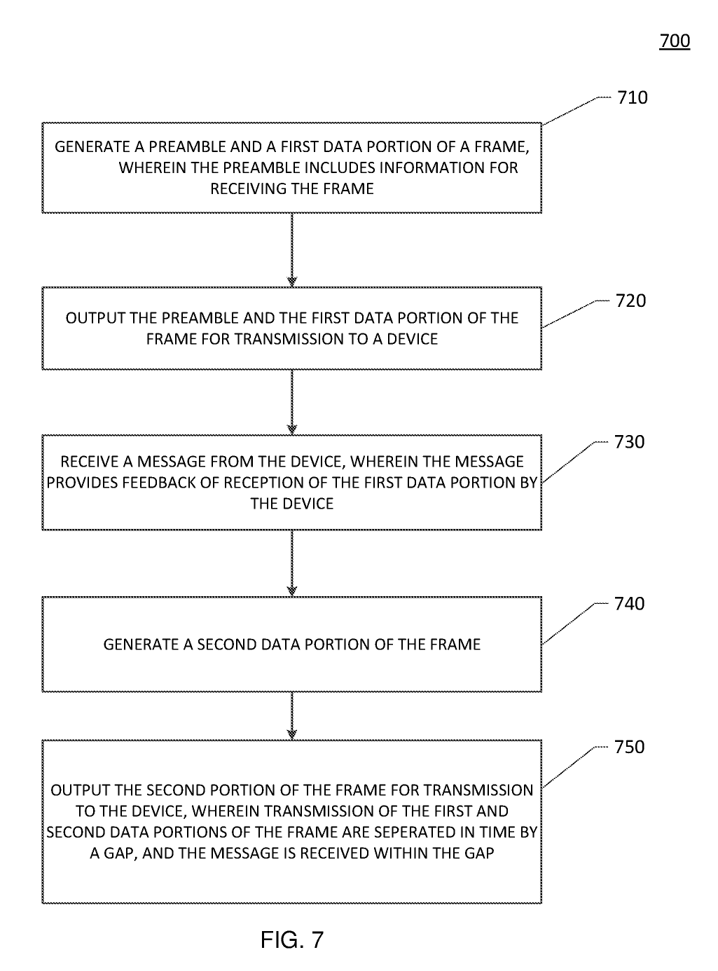

FIG. 7 is a flowchart illustrating a method 700 for wireless communication according to certain aspects of the present disclosure. The method 700 may be performed by an initiator.

At step 710, a preamble and a first data portion of a frame are generated, wherein the preamble includes information for receiving the frame at a device. For example, the information may include STF, CEF and/or a Header.

At step 720, the preamble and the first data portion of the frame are outputted for transmission to the device. For example, the preamble and first data portion (e.g., preamble 420 and first data portion 425-1) may be transmitted to a responder.

At step 730, a message is received from the device, wherein the message provides feedback of reception of the first data portion by the device. For example, the message may be a feedback message (e.g., FB message 430).

At step 740, a second data portion of the frame is generated. For example, the second data portion (e.g., second data portion 425-2) may include new data blocks and/or one or more data blocks from the first data portion for retransmission.

At step 750, the second data portion of the frame is outputted for transmission to the device, wherein transmission of the first and second data portions of the frame are separated in time by a gap, and the feedback message is received within the gap. For example, the gap (e.g., gap 415) may be relatively small (e.g., two microseconds or less) for high data throughput.

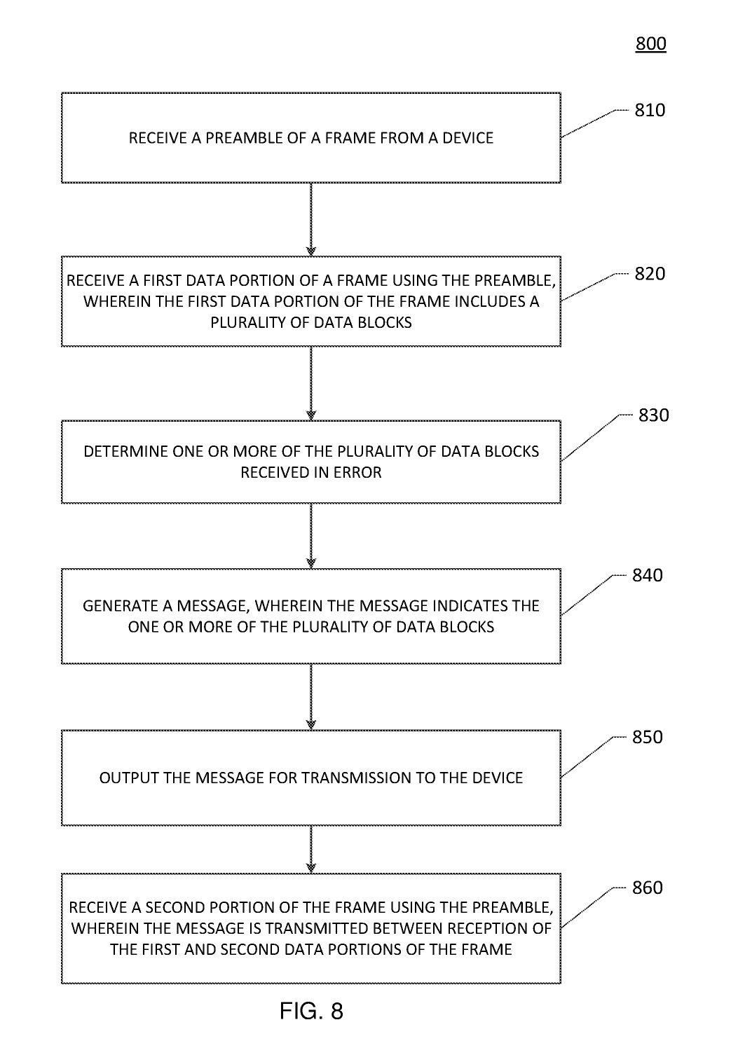

FIG. 8 is a flowchart illustrating a method 800 for wireless communication according to certain aspects. The method 800 may be performed by a responder.

At step 810, a preamble of a frame is received from a device. For example, the preamble (e.g., preamble 420) may include information (e.g., STF, CEF and/or a Header) for receiving data in the frame (e.g., frame 410).

At step 820, a first data portion of the frame is received using the preamble, wherein the first data portion of the frame includes a plurality of data blocks. For example, an STF in the preamble may be used for acquiring timing of the frame (e.g., symbol timing) for receiving the first data portion.

At step 830, a determination is made that one or more of the plurality of data blocks received in error. For example, each block may include a check sequence (e.g., CRC), and the determination may be made using the check sequences of the blocks.

At step 840, a message is generated, wherein the message indicates the one or more of the plurality of data blocks.

At step 850, the message is outputted for transmission to the device.

At step 860, a second portion of the frame is received using the preamble, wherein the message is output for transmission between reception of the first and second data portions of the frame.

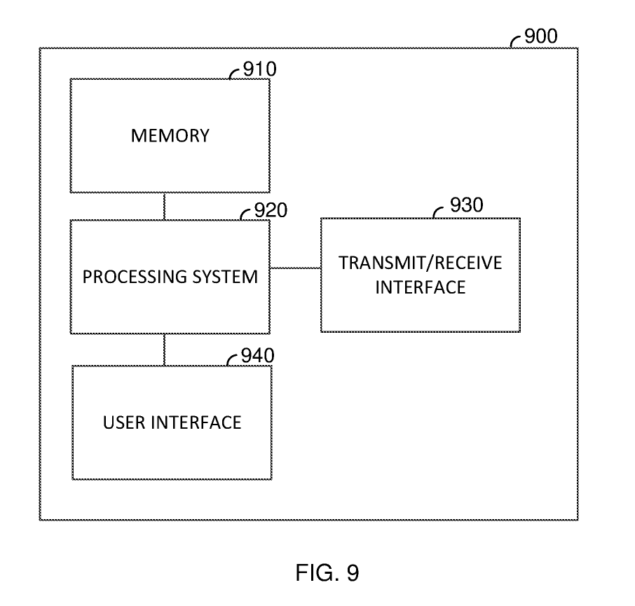

FIG. 9 illustrates an example device 900 according to certain aspects of the present disclosure. The device 900 may be configured to operate in a wireless node (e.g., access point 210 or access terminal 220) and to perform one or more of the operations described herein. The device 900 includes a processing system 920, and a memory 910 coupled to the processing system 920. The memory 910 may store instructions that, when executed by the processing system 920, cause the processing system 920 to perform one or more of the operations described herein. Exemplary implementations of the processing system 920 are provided below. The device 900 also comprises a transmit/receiver interface 930 coupled to the processing system 920. The interface 930 (e.g., interface bus) may be configured to interface the processing system 920 to a radio frequency (RF) front end (e.g., transceivers 226-1 to 226-N or 266-1 to 266-N).

In certain aspects, the processing system 920 may include one or more of the following: a transmit data processor (e.g., transmit data processor 218 or 260), a frame builder (e.g., frame builder 222 or 262), a transmit processor (e.g., transmit processor 224 or 264) and/or a controller (e.g., controller 234 or 274) for performing one or more of the operations described herein.

In the case of an access terminal 220, the device 900 may include a user interface 940 coupled to the processing system 920. The user interface 940 may be configured to receive data from a user (e.g., via keypad, mouse, joystick, etc.) and provide the data to the processing system 920. The user interface 940 may also be configured to output data from the processing system 920 to the user (e.g., via a display, speaker, etc.). In this case, the data may undergo additional processing before being output to the user. In the case of an access point 210, the user interface 940 may be omitted.

The transmit data processor 218 or 260, frame builder 222 or 262 and processing system 920 are examples of means for generating a preamble and a first data portion of a frame, wherein the preamble includes information for receiving the frame at a device. The transmit processor 224 or 264, transceivers 226 or 266 and interface 930 are examples of means for outputting the preamble and the first data portion of the frame for transmission to the device. The receive processor 242 or 282, transceivers 226 or 266 and interface 930 are examples of means for receiving a message from the device, wherein the message provides feedback of reception of the first data portion by the device. The transmit data processor 218 or 260, frame builder 222 or 262 and processing system 920 are examples of means for generating a second data portion of the frame. The transmit processor 224 or 264, transceivers 226 or 266 and interface 930 are examples of means for outputting the second data portion of the frame for transmission to the device, wherein transmission of the first and second data portions of the frame are separated in time by a gap, and the message is received within the gap.

The receive processor 242 or 282 and processing system 920 are examples of means for performing channel estimation using the STF, and means for decoding the received message based on the channel estimation. The receive processor 242 or 282 and processing system 920 are examples of means for performing time synchronization using the STF, and means for decoding the message is based on the time synchronization. The receive processor 242 or 282, controller 234 or 274 and processing system 920 are examples of means for determining a channel condition, and means for comparing the determined channel condition with a threshold, wherein the information includes an indication that the message is to be transmitted within the gap if the determined channel condition is above the threshold. The receive processor 242 or 282, controller 234 or 274 and processing system 920 are examples of means for decoding a portion of the message using the code assigned to the device. The receive processor 242 or 282, controller 234 or 274 and processing system 920 are examples of means for processing the received feedback data according to the indicated type of feedback data.

The receive processor 242 or 282, controller 234 or 274 and processing system 920 are examples of means for performing error detection on the feedback data using the check sequence. The receive processor 242 or 282, controller 234 or 274 and processing system 920 are examples of means for determining whether the message is received in error using the check sequence.

The receive processor 242 or 282, transceivers 226 or 266 and interface 930 are examples of means for receiving, from a device, a preamble of a frame. The receive processor 242 or 282, transceivers 226 or 266 and interface 930 are examples of means for receiving a first data portion of the frame using the preamble, wherein the first data portion of the frame includes a plurality of data blocks. The receive processor 242 or 282, controller 234 or 274 and processing system 920 are examples of means for determining one or more of the plurality of data blocks is received in error. The transmit data processor 218 or 260 and processing system 920 are examples of means for generating a message, wherein the message indicates the one or more of the plurality of data blocks. The transmit processor 224 or 264, transceivers 226 or 266 and interface 930 are examples of means for outputting the message for transmission to the device. The receive processor 242 or 282, transceivers 226 or 266 and interface 930 are examples of means for receiving a second portion of the frame using the preamble, wherein the message is output for transmission between reception of the first and second data portions of the frame.

The receive processor 242 or 282, controller 234 and processing system 920 are examples of means for performing time synchronization using the STF, and means for decoding the first and second data portions based on the time synchronization. The receive processor 242 or 282, controller 234 or 274 and processing system 920 are examples of means for performing channel estimation using the CEF, and means for decoding the first and second data portions based on the channel estimation. The transmit processor 224 or 264 and processing system 920 are examples of means for encoding a portion of the feedback message with a code assigned to the second device. The transmit processor 224 or 264, transceivers 226 or 266 and interface 930 are examples of means for outputting the message for transmission to the device at approximately the indicated time. The receive processor 242 or 282 and processing system 920 are examples of means for initializing a time tracking loop using the STF, and means for maintaining the time tracking loop using the first plurality of pilots and the second plurality of pilots to track timing of the first and second data portions.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of an access terminal 220 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by an access terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that an access terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
a processing system configured to:
generate a preamble and a first data portion of a frame, wherein the preamble includes information for receiving the frame at a device;
receive a message from the device, wherein the message provides feedback of reception of the first data portion by the device; and
generate a second data portion of the frame; and
an interface configured to:
output the preamble and the first data portion of the frame for transmission to the device; and
output the second data portion of the frame for transmission to the device, wherein transmission of the first and second data portions of the frame are separated in time by a gap, and the message is received within the gap.

2. The apparatus of claim 1, wherein the information includes at least one of a short training field (STF), a channel estimation field (CEF), or a header.

3. The apparatus of claim 1, wherein the gap is approximately equal to or less than two microseconds.

4. The apparatus of claim 1, wherein the first data portion of the frame includes a plurality of data blocks, the message includes a block acknowledgement (BA) indicating one or more of the plurality of data blocks received in error by the device, and the second data portion of the frame includes the one or more of the plurality of data blocks.

5. The apparatus of claim 1, wherein the message includes a short training field (STF), and the processing system is configured to:
perform channel estimation using the STF; and
decode the message based on the channel estimation.

6. The apparatus of claim 1, wherein the message includes a short training field (STF), and the processing system is configured to:
perform time synchronization using the STF; and
decode the message based on the time synchronization.

7. The apparatus of claim 1, wherein the information includes a length field indicating a length of the frame, a first portion of the length is allocated for transmission of a plurality of data blocks, and a second portion of the length is allocated for retransmission of one or more of the plurality of data blocks.

8. The apparatus of claim 1, wherein the processing system is configured to:
determine a channel condition;
compare the determined channel condition with a threshold; and
if the determined channel condition is above the threshold, include in the information an indication that the message is to be transmitted within the gap.

9. The apparatus of claim 1, wherein a portion of the message is encoded with a code assigned to the device, and the processing system is configured to decode the portion of the message using the code.

10. The apparatus of claim 1, wherein the information includes an indication of a time of the gap.

11. The apparatus of claim 1, wherein the message includes a field and a data block, the field indicating a type of feedback data in the data block, and wherein the processing system is configured to process the feedback data according to the indicated type of feedback data.

12. The apparatus of claim 1, wherein the message includes feedback data and a check sequence, and the processing system is configured to perform error detection on the feedback data using the check sequence.

13. The apparatus of claim 1, wherein the message includes a check sequence, and the processing system is configured to:
determine whether the message is received in error using the check sequence, wherein the second data portion includes an indication of the determination of whether the message was received in error.

14. The apparatus of claim 1, wherein the message includes a request to use a different feedback format for a next message, and the second data portion of the frame includes an acknowledgement of the request.

15. The apparatus of claim 1, wherein a first time duration between transmission of the first data portion and reception of the message is different from a second time duration between reception of the message and transmission of the second data portion.

16.-46. (canceled)

47. A wireless node, comprising:
a processing system configured to:
generate a preamble and a first data portion of a frame, wherein the preamble includes information for receiving the frame at a device;
receive a message from the device, wherein the message provides feedback of reception of the first data portion by the device; and
generate a second data portion of the frame; and
a transmitter configured to:
transmit the preamble and the first data portion of the frame to the device; and
transmit the second data portion of the frame to the device, wherein transmission of the first and second data portions of the frame are separated in time by a gap, and the message is received within the gap.

48. An apparatus for wireless communications, comprising:
a processing system configured to:
receive, from a device, a preamble of a frame;
receive a first data portion of the frame using the preamble, wherein the first data portion of the frame includes a plurality of data blocks;
determine one or more of the plurality of data blocks received in error by the apparatus;
generate a message, wherein the message indicates the one or more of the plurality of data blocks; and
receive a second portion of the frame using the preamble; and
an interface configured to output the message for transmission to the device between reception of the first and second data portions of the frame.

49. The apparatus of claim 48, wherein the preamble of the frame includes a short training field (STF), and the processing system is configured to:
perform time synchronization using the STF; and
decode the first and second data portions based on the time synchronization.

50. The apparatus of claim 48, wherein the preamble of the frame includes a channel estimation field (CEF), and the processing system is configured to:
perform channel estimation using the CEF; and
decode the first and second data portions based on the channel estimation.

51. The apparatus of claim 48, wherein the gap is approximately equal to or less than two microseconds.

52. The apparatus of claim 48, wherein the processing system is configured to encode a portion of the message with a code assigned to the apparatus.

53. The apparatus of claim 48, wherein the preamble of the frame includes an indication of a time of the gap, and the interface is configured to output the message for transmission to the device at approximately the indicated time.

54. The apparatus of claim 48, wherein the message includes a field and a data block, the field indicating a type of feedback data in the data block.

55. The apparatus of claim 48, wherein the preamble of the frame includes a short training field (STF), the first data portion includes a first plurality of pilots, and the second data portion includes a second plurality of pilots, and the processing system is configured to:
initialize a time tracking loop using the STF; and
maintain the time tracking loop using the first plurality of pilots and the second plurality of pilots to track timing of the first and second data portions.

56.-73. (canceled)
